(19) United States
(12) Patent Application Publication
(10) Pub. No.: US 2026/0182785 A1
(43) Pub. Date: Jul. 2, 2026

(54) Canned Food Press (CFP)

(71) Applicant: Brian C. Lloyd, Leonardtown, MD (US)

(72) Inventor: Brian C. Lloyd, Leonardtown, MD (US)

(21) Appl. No.: 19/004,402

(22) Filed: Dec. 29, 2024

(51) Int. Cl. A47J 43/28; B30B 9/10

(52) U.S. Cl. CPC A47J 43/286; B30B 9/10

(57) ABSTRACT

An apparatus for expelling fluid from a can using two handles made up of a lower handle with base for canned food can to rest upon and an upper handle with a basket connected by a hinge at the fore front of the apparatus.

### BACKGROUND

Currently all hand-held CFP's require you to hold both the press and the can at the same time. Thus allowing for the excess fluid in the can to run down your hands. My version of the CFP allows for your hands to not get all the excess fluid all over them. A single example of this would be canned tuna fish. If you held both the can and a manual press at the same time you have a much greater opportunity to get oil or water on your hands.

Similar attempts: Here are some similar attempts to achieve the desired results of draining excess fluid from a can all the while keeping the canned food within the can. Examples include U.S. Pat. No. Des. 311,116 and Des. 343,995 as well as U.S. Pat. Nos. 3,995,544; 4,860,647; 5,501,144; and 5,706,721.

### SUMMARY

The CFP is a hand-held device that compresses the food in the can so as to remove excess fluid. The device is hinged (via a pin in option 1 and fabricated formations in option 2, see figures.) at the top with the top lever coming down into the can that sits on the base lever. This design allows for the user to apply additional pressure via the handles so extra excess fluid can be expelled.

### DESCRIPTION OF IMAGES

### (Separate PDF File)

Option 1: CFPopt1a—Upper left side view

### DESCRIPTION

### THE DRAWINGS

FIG. 1 is a side elevational view of the device for pressing fluid from a can of food;

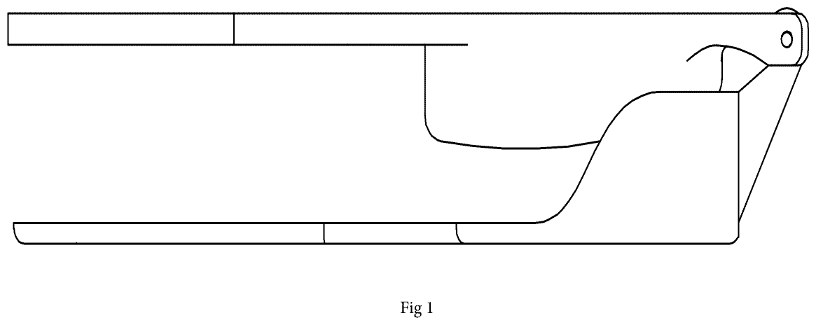

FIG. 2 is a top view of the device shown in FIG. 1;

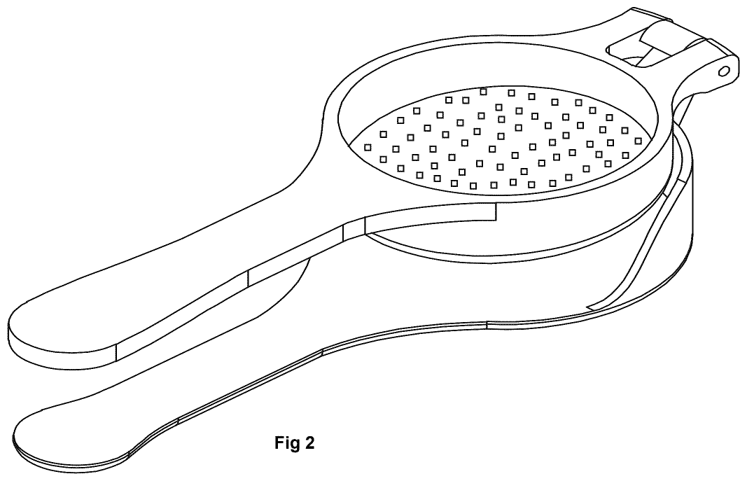

FIG. 3 is an opened front view of the device shown in FIGS. 1-2;

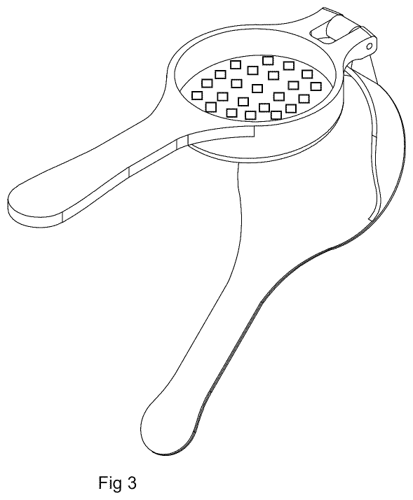

FIG. 4 is a disassembled pin hinge view of the device shown in FIGS. 1-3;

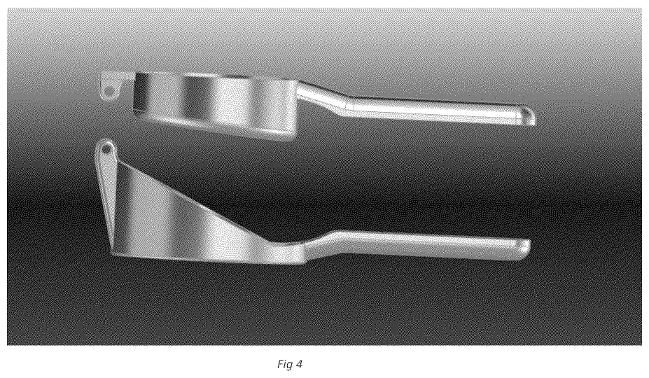

FIG. 5 is a front elevational view of the device shown in FIGS. 1-4;

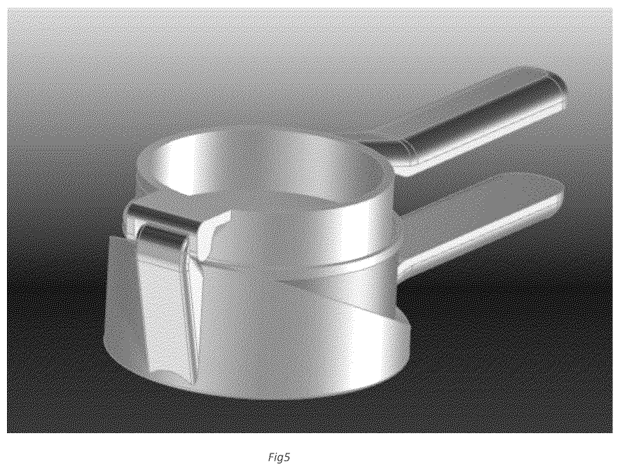

FIG. 6 is an additional side elevational view of the device shown in FIGS. 1-5;

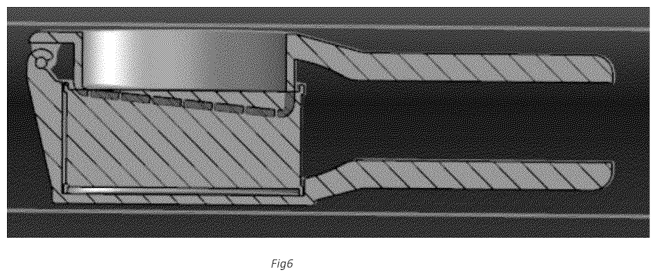

FIG. 7 is a closeup of fabricated form hinge elevational view of the device shown in FIGS. 1-6;

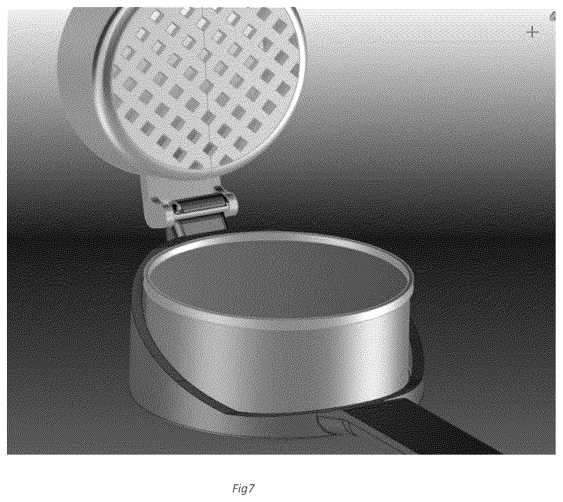

1. A hand held apparatus for removing fluid from a can. Made up of 2 handles that are hinged at 1 point allowing the user to squeeze the fluid from the can, by placing the can on the lower handle platform and bringing down the upper handle with a basket into the can containing the fluid.
